(19) United States
(12) Patent Application Publication
(10) Pub. No.: US 2022/0356980 A1
(43) Pub. Date: Nov. 10, 2022

(54) HEAT SHIELDS AND INSULATED ENCLOSURES

(71) Applicant: Thermal Structures, Inc., Corona, CA (US)

(72) Inventor: Brett Miller, Corona, CA (US)

(21) Appl. No.: 17/741,377

(22) Filed: May 10, 2022

Related U.S. Application Data
(60) Provisional application No. 63/186,702, filed on May 10, 2021.

(51) Int. Cl. F16L 59/04

(52) U.S. Cl. CPC F16L 59/04

(57) ABSTRACT

A thermal insulating structure comprising a top, a bottom, first and second sides, a thermal insulating material, and a first transverse member is contemplated. The thermal insulating material is disposed between the first and second sides. The first transverse member comprises a plurality of apertures, which thereby provides less material of the transverse member for heat transfer compared to an identical transverse member with no apertures. Thus, the path for heat transfer through the first transverse member is restricted and the effect of an undesirable “hot spot” is reduced or eliminated.

This application claims priority to U.S. Provisional Patent Application Ser. No. 63/186,702, filed May 10, 2021. All extrinsic materials identified herein are incorporated by reference in their entirety.

### FIELD OF THE INVENTION

The field of the invention is insulating systems and structures.

### BACKGROUND

The background description includes information that may be useful in understanding the present invention. It is not an admission that any of the information provided herein is prior art or relevant to the presently claimed invention, or that any publication specifically or implicitly referenced is prior art.

Heat shields and thermally insulated enclosures exist to provide thermal insulation in various systems. Heat shields and thermally insulated enclosures, especially those which operate at high temperatures, are often constructed of an insulating material (or materials), that is then encapsulated or encased, by rigid or semirigid material to protect the insulation from mechanical damage. Typically, the encapsulating or encasing material provides little to no insulation value, and commonly comprise metals in high temperature applications, such as a stainless-steel sheet and/or foil.

When metals are used to encapsulate or encase insulation, it is common to have transverse metallic members within the insulated shield or enclosure due to functional and mechanical requirements. Transverse metallic members create a path of low thermal resistance relative to the adjacent insulated regions (i.e., transverse metallic members create “hot spots” where high thermal conduction can occur). Consequently, these transverse metallic members can lead to undesirable thermal performance of the insulated shield or enclosure.

Thus, there is still a need in the art for improved insulating systems and structures that minimize the undesirable properties described above.

### SUMMARY OF THE INVENTION

The inventive subject matter provides apparatus, systems, and methods in which the undesirable properties commonly associated with transverse members of insulated systems and structures are minimized. A thermal insulating structure comprising a top, a bottom, first and second sides, a thermal insulating material, and a first transverse member is contemplated. The thermal insulating material is disposed between the first and second sides. The first transverse member comprises a plurality of apertures, which thereby provides less material of the transverse member for heat transfer compared to an identical transverse member with no apertures. Thus, the path for heat transfer through the first transverse member is restricted and the effect of an undesirable “hot spot” is reduced or eliminated.

In some embodiments, the first transverse member is coupled to the first and second sides. The first transverse member comprises a raised edge that is fastened onto the first side. An opposite end of the first transverse member can be held between first and second rims of the second side. In other embodiments, the first transverse member is an extension of the first side and couples to second side. The first transverse member can be held between first and second rims of the second side.

The thermal insulating structure can include a second transverse member. The second transverse member extends between the first and second sides, and includes a plurality of apertures to thereby reduce heat transfer through the second transverse member. The first and second transverse members can be stacked, such that the plurality of apertures of the first transverse member align with the plurality of apertures of the second transverse member. It should be appreciated that the apertures are aligned to reduce heat transfer that may otherwise occur by having an aperture of one transverse member directly above or below a solid region of another transverse member.

In some embodiments, the top, the bottom, and the first and second sides are made of one or more metals. Additionally, or alternatively, the first transverse member is made of one or more metals.

In another aspect, a system comprising a thermal insulating structure that separates first and second areas is contemplated. The first area comprises a first temperature and the second area comprises a second temperature that is higher than the first temperature. The thermal insulating structure comprises (i) a housing having a first side exposed to the first area and a second side exposed to the second area, (ii) a thermal insulating material within the housing, and (iii) a transverse member that extends between first and second sides of the housing. The transverse member comprises a plurality of apertures to thereby reduce heat transfer between the first and second areas via the first transverse member.

It is contemplated that the one or more of the first and second areas are disposed in a fuel cell enclosure, a battery enclosure, a combustion engine insulation system, a marine powertrain isolation and shielding system, or a refrigeration enclosure.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a perspective view of an embodiment of a thermal insulating structure.

FIG. 2 is another perspective of the thermal insulating structure of FIG. 1.

FIG. 3 is an enlarged view of first and second transverse members of the thermal insulating structure of FIG. 1.

FIG. 4 is a perspective view of the thermal insulating structure of FIG. 1 having thermal insulating material.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The inventor has discovered that transverse members can be provided in insulated systems and structures that minimize undesirable heat transfer commonly associated with transverse members. For example, a transverse member can be provided that has apertures to reduce the material in which undesirable heat transfer can occur. Thus, heat transfer through the transverse member is reduced.

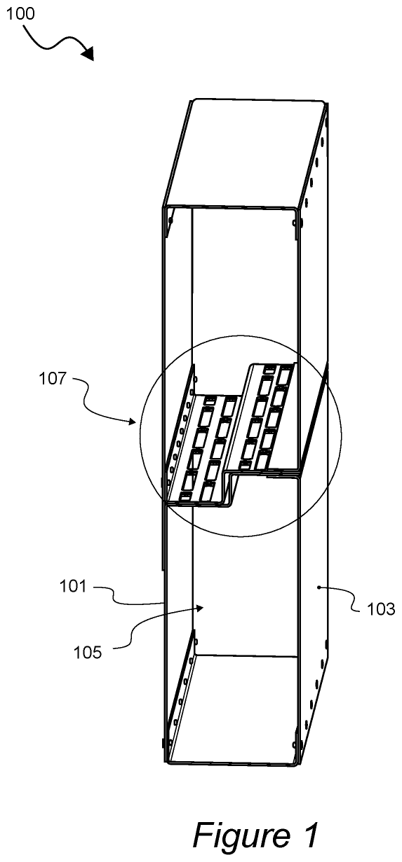

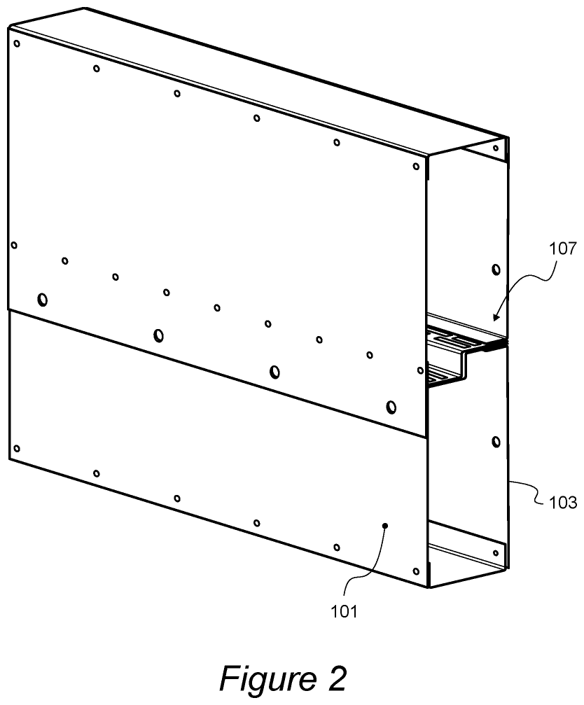

FIGS. 1-2 show a thermal insulating structure 100 that can house thermal insulating material. Thermal insulating structure 100 comprises a top, a bottom, a first side 101, and a second side 103. One or more transverse members 107 can extend between first side 101 and second side 103 to provide structural integrity to thermal insulating structure 100. As will be shown in greater detail below, one or more transverse members 107 can comprise apertures to thereby reduce undesired heat transfer through thermal insulating structure 100.

It is contemplated that thermal insulating structure 100 can be used to separate a first area (e.g., the area to the left of thermal insulating structure 100 in FIG. 1) having a first temperature from a second area (e.g., the area to the right of thermal insulating structure 100 in FIG. 1) having a second temperature that is higher than the first temperature. In such embodiments, it should be appreciated that the apertures through the one or more transverse members 107 reduce the material through which undesired heat transfer can occur between the first and second areas via the one or more transverse members 107.

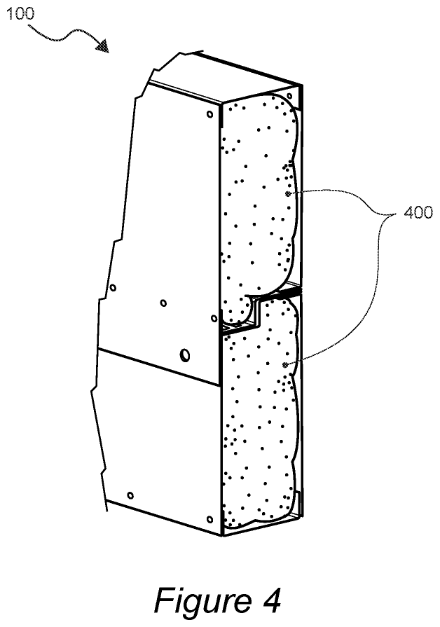

Thermal insulating material can be disposed within an inner volume 105 of thermal insulating structure 100 to reduce heat transfer through or into thermal insulating structure 100. An example of thermal insulating material within thermal insulating structure 100 will be described below (see FIG. 4).

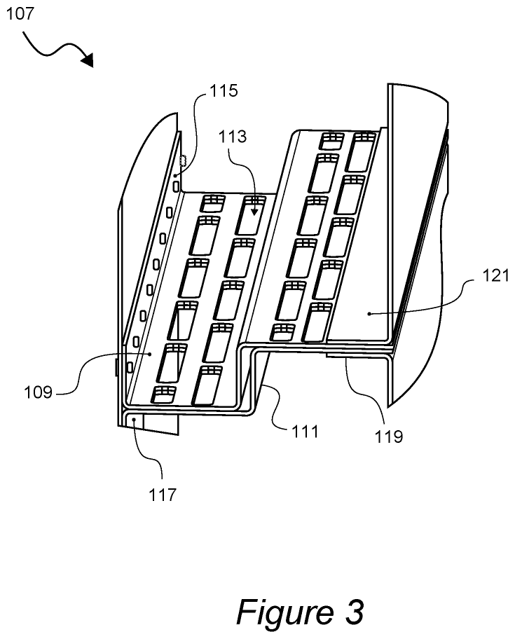

FIG. 3 shows an enlarged view of the one or more transverse members 107. As shown, a first transverse member 109 and a second transverse member 111 extend between first side 101 and second side 103. First transverse member 109 and second transverse member 111 comprise a plurality of apertures 113. As discussed above, a plurality of apertures 113 reduces the material in which undesirable heat transfer via first transverse member 109 and second transverse member 111 can occur through thermal insulating structure 100. It is contemplated that one or more of first transverse member 109 and second transverse member 111 can comprise more or less apertures than shown in FIG. 3.

First transverse member 109 comprises a raised edge 115 that is fastened onto first side 101. An opposite end of first transverse member 109 can be held between a first rim 119 and a second rim 121 of second side 103 as shown in FIG. 3. Furthermore, second transverse member 111 can be held between first rim 119 and second rim 121 as shown in FIG. 3. The opposite end of second transverse member 111 can be an extension of first side 101 (see FIG. 2 showing bottom portion of first side 101 extending into thermal insulating structure 100 to form second transverse member 111).

FIG. 4 shows an example of thermal insulating structure 100 having thermal insulating material 400. It is contemplated that the type, amount, and use of thermal insulating material 400 can vary depending on the application for thermal insulating structure 100. It is contemplated that thermal insulating structure 100 can be incorporated in or as a fuel cell enclosure, a battery enclosure, a combustion engine insulation system, a marine powertrain isolation and shielding system, or a refrigeration enclosure. FIG. 1 is shown without insulation for clarity to show one or more transverse members 107.

Although FIGS. 1-3 show an example of transverse members having apertures, which reduce the material for undesired heat transfer, it should be appreciated that the extent and exact geometry of the material removed from the transverse members can vary depending on the use of the thermal insulating structure. Furthermore, it is contemplated that a material, such as stainless-steel foil, can be attached to one or more sides of the thermal insulating structure to improve the containment of material or fluid flow.

It is also conceivable that this method for reducing heat flow could be employed where it is desirable to restrict the conductive transfer of heat flow by other features, such as through holes, pass-throughs, openings, or shield structure terminations. It is also conceivable that the effects of this invention could be achieved through construction of a member which reduces material in such a way that heat flow is restricted. Although it is contemplated that the housing (top, bottom, first and second sides) and the one or more transverse members can be made of one or more metals, the application of this invention is not limited to metallic members. Applications where this invention would be beneficial include but are not limited to, fuel cell enclosures, battery enclosures, combustion engine insulation systems, marine powertrain isolation and shielding systems, and refrigeration enclosures.

It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A thermal insulating structure, comprising:
a top and a bottom;
a first side and a second side;
a thermal insulating material between the first and second sides;
a first transverse member that extends between the first and second sides; and
wherein the first transverse member comprises a plurality of apertures to thereby reduce heat transfer through the first transverse member.

2. The structure of claim 1, wherein the top is coupled to the first and second sides, and the bottom is coupled to the first and second sides.

3. The structure of claim 1, wherein the second side comprises a first rim and a second rim that both extend toward the first side, and wherein a portion of the first transverse member is held between the first and second rims.

4. The structure of claim 3, wherein the first transverse member comprises a raised edge that is fastened to the first side.

5. The structure of claim 1, wherein the first transverse member comprises a raised edge that is fastened to the first side.

6. The structure of claim 1, further comprising a second transverse member that extends between the first and second sides, and wherein the second transverse member comprises a plurality of apertures to thereby reduce heat transfer through the second transverse member.

7. The structure of claim 6, wherein the first side comprises a top portion and a bottom portion, and wherein the bottom portion comprises the second transverse member.

8. The structure of claim 6, wherein the first transverse member is stacked above the second transverse member, and further wherein the plurality of apertures of the first transverse member align with the plurality of apertures of the second transverse member.

9. The structure of claim 8, wherein the second side comprises a first rim and a second rim that both extend toward the first side, and wherein a portion of the first transverse member and a portion of the second transverse member are held between the first and second rims.

10. The structure of claim 9, wherein the first transverse member comprises a raised edge that is fastened to the first side.

11. The structure of claim 1, wherein the first transverse member has a higher thermal conductivity than the thermal insulating material.

12. The structure of claim 1, wherein the top, the bottom, and the first and second sides are made of one or more metals.

13. The structure of claim 12, wherein the first transverse member is made of one or more metals.

14. A system, comprising:
a first area comprising a first temperature;
a second area comprising a second temperature that is higher than the first temperature;
a thermal insulating structure that separates the first area and the second area; and
wherein the thermal insulation structure comprises:
a housing having a first side exposed to the first area and a second side exposed to the second area;
a thermal insulating material within the housing;
a transverse member that extends between first and second sides of the housing; and
wherein the transverse member comprises a plurality of apertures to thereby reduce heat transfer between the first and second areas via the first transverse member.

15. The system of claim 14, wherein the housing comprises a first rim and a second rim, and wherein a portion of the transverse member is held between the first and second rims.

16. The system of claim 15, wherein the transverse member comprises a raised edge that is fastened to the housing.

17. The system of claim 15, wherein a side of the housing comprises a top portion and a bottom portion, and wherein the bottom portion comprises the transverse member.

18. The system of claim 14, wherein the housing is made of one or more metals.

19. The system of claim 18, wherein the transverse member is made of one or more metals.

20. The system of claim 14, one or more of the first and second areas are disposed in a fuel cell enclosure, a battery enclosure, a combustion engine insulation system, a marine powertrain isolation and shielding system, or a refrigeration enclosure.
